(19) United States
(12) Patent Application Publication
(10) Pub. No.: US 2011/0243442 A1
(43) Pub. Date: Oct. 6, 2011

(54) Video Camera for Acquiring Images with Varying Spatio-Temporal Resolutions

(76) Inventors: Amit K. Agrawal, Somerville, MA (US); Ashok Veeraraghavan, North Cambridge, MA (US); Srinivasa G. Narasimhan, Presto, PA (US); Mohit Gupta, Pittsburgh, PA (US)

(21) Appl. No.: 12/751,216

(22) Filed: Mar. 31, 2010

(51) Int. Cl. H04N 5/262; G06K 9/34

(52) U.S. Cl. 382/173; 348/239; 348/E05.051

(57) ABSTRACT

A sequence of images of a scene having varying spatio-temporal resolutions is acquired by a sensor of a camera. Adjacent pixels of the sensor are partitioned into a multiple sets of the pixels. An integration time for acquiring each set of pixels is partitioned into multiple time intervals. The images are acquired while some of the pixels in each set are ON for some of the intervals, while other pixels are OFF. Then, the pixels are combined into a space-time volume of voxels, wherein the voxels have varying spatial resolutions and varying temporal resolutions.

### FIELD OF THE INVENTION

This invention relates generally to videography, and more particularly to acquiring videos with varying spatio-temporal resolution.

### BACKGROUND OF THE INVENTION

A video camera is designed to take into account trade-offs between spatial resolution (SR), and temporal resolution (TR). The camera can acquire a fixed number of voxels of a scene over time, i.e., a space-time volume V(x, y, t).

As shown in FIG. 1, the shape of the voxels can vary from thin in space and long in time for high SR and low TR, to fat in space and short in time for high TR and low SR, as shown in FIG. 2.

Videos of real world scenes can have a wide range of motions, from static objects 101 to rapidly moving objects 102. A high SR camera that acquires fine spatial details has large motion blur. A high TR camera looses details even for static and slow moving regions of the scene.

As shown in FIG. 3, region-of-interest (ROI) binning crops the field of view to gain temporal resolution. Acquiring such a sequence requires different voxel shapes at different locations in the space-time volume. However, for conventional video cameras, the shape of the voxels is the same for the entire sensor array, and is fixed before images of the scene are acquired.

In the prior art, multiple-resolution images, for the purpose of maximizing resolution and minimizing motion blur, are typically acquired by multiple cameras. Those techniques require as many cameras the number of desired spatio-temporal resolutions. The need for the cameras to be registered with each other places severe constraints on the scenes or requires the cameras to be co-located. Region-of-interest (ROI) binning, see FIG. 3, acquires different spatio-temporal resolutions at different sensor locations. However, ROI binning only has one resolution per sensor location. Thus, the resolution for each sensor still must be predetermined

Another fundamental trade-off in the video camera is between the temporal resolution and the signal-to-noise ratio (SNR). It is well known that high-speed cameras suffer from high image noise in lowlight conditions. Fast shutters have been used for motion deblurring and resolution enhancement.

For a conventional video camera, the sampling of the space-time volume is decided before images are acquired. Given a fixed number voxels, a high SR camera samples the temporal dimension sparsely, resulting in large motion blur, and aliasing. A high-speed camera unnecessarily trades SR for TR, even for the static and slow-moving regions of the scene.

It is desired to vary the spatial and temporal resolution in a video based on the content of the images.

### SUMMARY OF THE INVENTION

The invention provides a method for acquiring a sequence of images (video) with a single camera that can have variable spatio-temporal resolution. The camera samples the space-time volume, i.e., a scene over time, in such way that it enables changing shapes of voxels, after the voxels are acquired.

Flexible sampling achieves different combinations of spatial resolutions (SR) and temporal resolution (TR) across a space-time volume, resulting in maximal spatial detail, while minimizing motion blur.

The sampling can also use multiplexed sampling. Multiplexing enables acquiring more light per-pixel.

It is an object of the invention to acquire videos amenable to a variety of post-acquisition interpretations. Depending on the content at each space location and time intervals, different combinations of spatial and temporal resolutions can be selected.

Image segmentation, or background subtraction can be used to identify static and moving region of the scene to automatically select the various spatio-temporal resolutions.

An active implementation uses structured light from a projector to illuminate the scene during the of each image.

A passive implementation uses an on-chip solution to vary the integration time for each pixel.

### BRIEF DESCRIPTION OF THE DRAWINGS

FIG. 1 is a schematic of voxels acquired at a high spatial resolution;

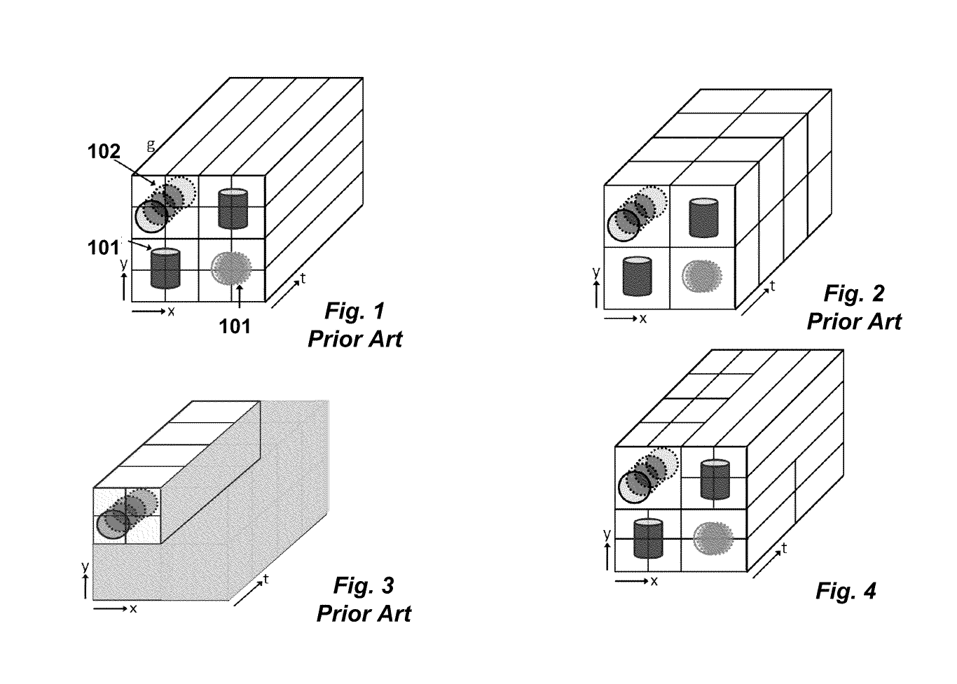

FIG. 2 is a schematic of voxels acquired at a high temporal resolution;

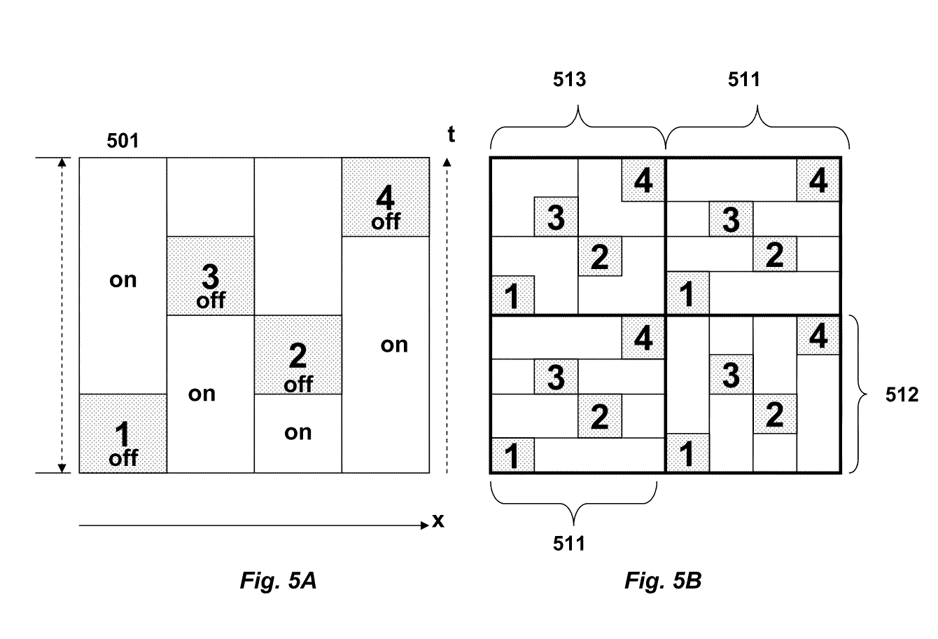

FIG. 3 is a schematic of voxels acquire using region-of-interest binning;

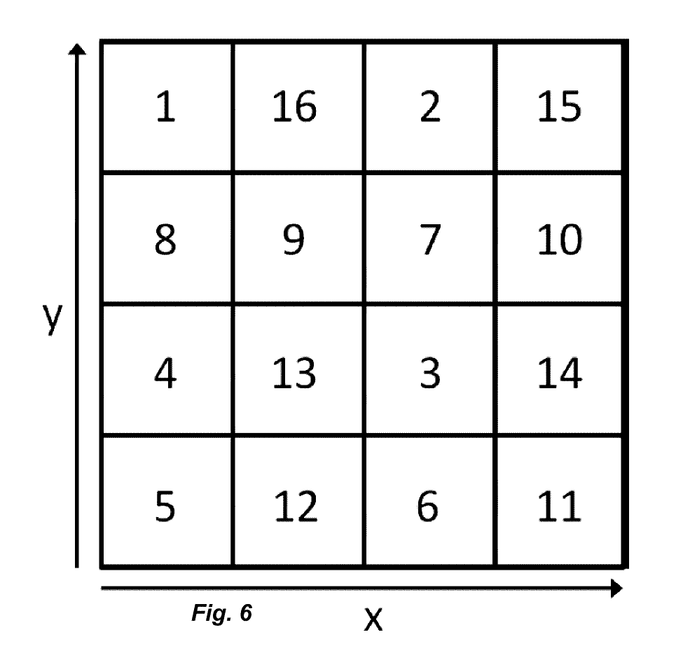

FIG. 4 is a schematic of voxels acquired with varying spatio-temporal resolutions according to embodiments of the invention;

FIG. 5A is a schematic of four adjacent pixels with partitioned according to embodiments of the invention;

FIG. 5B is a schematic of the four pixels arranged to provide different effective spatio-temporal resolutions during post processing according to embodiments of the invention;

FIGS. 6-10 are schematics of pixels arranged in an increasing temporal resolution, and a decreasing spatial resolution according to embodiments of the invention;

FIG. 11 is a schematic of multiplexed pixel according to embodiments of the invention;

FIG. 12 is a schematic of a camera according to embodiments of the invention with passive illumination;

FIG. 13 is a schematic of a camera and projector according to embodiments of the invention with active illumination; and

FIG. 14 is a block diagram of a method according to embodiments of the invention.

### DETAILED DESCRIPTION OF THE PREFERRED EMBODIMENTS

Content-Aware Variable Sampling of a Space-Time Volume

The embodiments of the invention provide a method for sampling a space-time volume using content-aware flexible sampling.

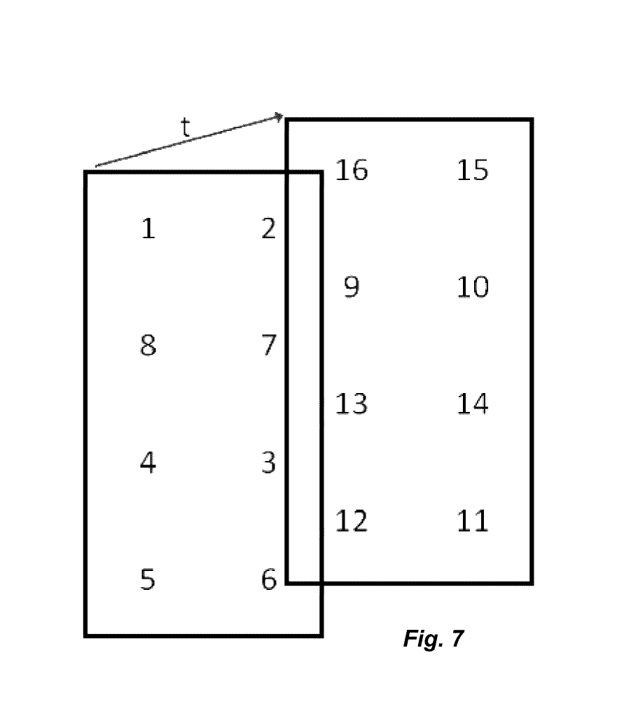

Therefore, as shown in FIG. 4, we acquire a sequence of images (video) at multiple spatio-temporal resolutions currently with a single video camera.

Voxels in the images at multiple spatio-temporal resolutions are amenable to a variety of post-processing operations. The processed voxels can then be combined spatially and temporally to minimize motion blur for moving objects, while keeping a high spatial resolution for static objects.

Acquiring Multiple Space-Time Resolutions Concurrently

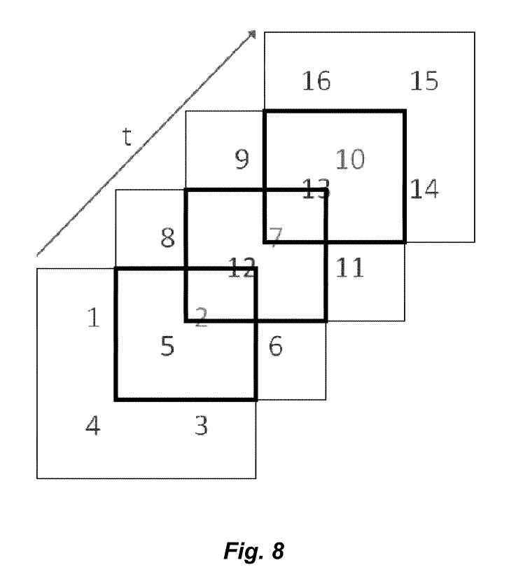

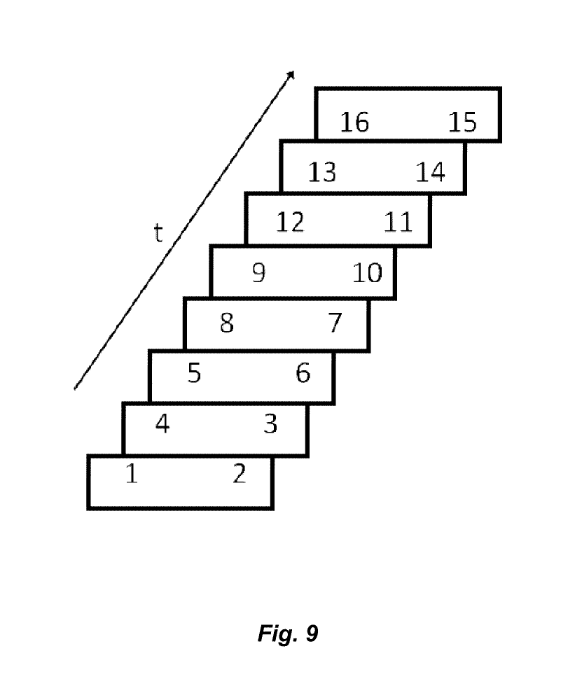

FIG. 5A shows a set of four adjacent pixels 1-4 in space x and time t. We partition integration time 501 of the camera sensor into (four) equal intervals. Each of the four pixels is ON for some, e.g., one or two, of the intervals during the time of a single image, and OFF otherwise. Here, white indicates ON, and texture indicates OFF. By switching each pixel ON during a different time interval, we ensure that each pixel has sampled the space-time volume at different locations and different time intervals.

Conventionally, the integration time is from when the shutter opens until the shutter closes. According to the invention, pixels integrate only when the pixels are on, which can be a fraction of the integration time for each image.

Thus, for a set of K adjacent pixels, each pixel is on for a temporal sub-interval of length 1/K. Each pixel samples the space-time volume V at different locations x.

As shown in FIG. 5B, we can achieve different effective spatio-temporal resolutions by simply arranging these measurements differently during the post processing.

Four pixels 511 are interpreted as temporal samples. This arrangement assumes spatial smoothness, i.e., a spatial resolution is 1/4, and results in a fourfold gain in temporal resolution. We call this arrangement [4, 1/4].

Four pixels 512 are interpreted as spatial samples. This arrangement assumes temporal smoothness, i.e., a static scene. We call this arrangement [1, 1/1].

For four pixel 513, pixels 1 and 2 are used as different spatial samples, but the same temporal samples, and pixels 3 and 4 are used as different spatial samples but the same temporal samples 513. For this, we assume part spatial-smoothness and part temporal-smoothness. We call this arrangement [2, 1/2].

In general, if we are using a set of K pixels, then the number of different resolutions possible is equal to the number of distinct divisors of K. The maximum temporal resolution gain is K. For example, if we use a set of 4×4=16 pixels, we can measure five different resolutions, with a maximum temporal resolution gain of 16. The locations are staggered so that if we partition the K pixels into P sub-sets of consecutive temporal locations, each set spreads out evenly across the K-neighborhood.

It is understood that other arrangements are also possible, e.g., 2×2, 8×8, etc. The only requirement is that some pixels are for controlling the spatial resolution, and others are used for controlling the temporal resolution,

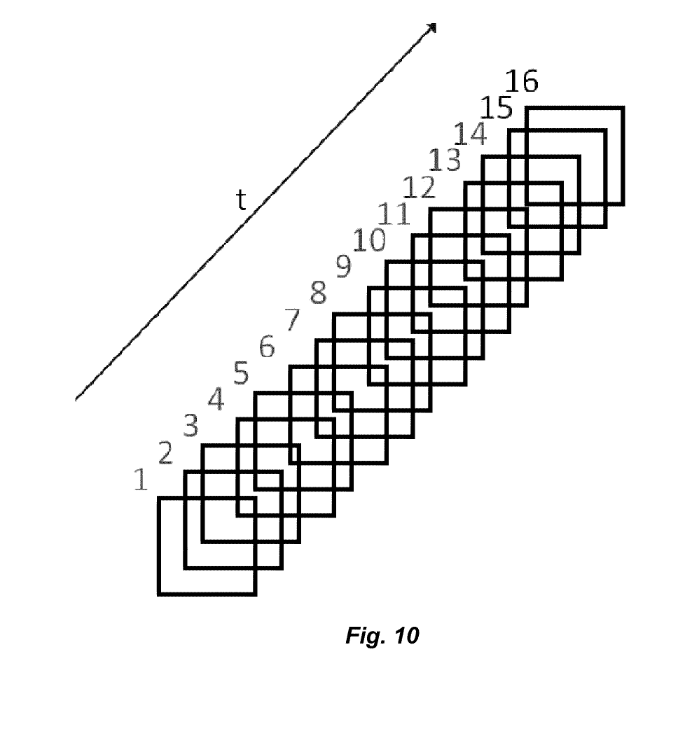

FIGS. 6-10 shows the temporal firing order for the spatial grouping of 4×4 pixels, respectively, as compared to the acquired image. Each pixel is on for 1/16 of the time of a single image. As before, different spatio-temporal arrangements of the measurements result in different [TR, SR] factors: [1, 1/1], [2, 1/2], [4, 1/4], [8, 1/8], and [16, 1/16]. FIGS. 6-10 are arranged in an increasing temporal resolution, and a decreasing spatial resolution.

Because we have acquired multiple spatio-temporal resolutions at each image location, the spatio-temporal resolution (voxel shape) can be determined independently for each space location and time interval during the post processing. Regions in the images can be marked for the different desired space-time resolutions.

If only fast-moving regions are marked, then, we minimize the motion blur on a fast moving object, as well as keep high spatial resolution on the static and slow moving s of the scene.

The marking can be performed automatically by using background subtraction or motion-segmentation to identify pixels associated with moving objects.

Multiplexed Sensing for High SNR

One disadvantage of switching the pixels on for only a fraction of the time is that each pixel receives less light leading to low signal-to-noise ratio (SNR). The tradeoff between temporal resolution and SNR is well known. High-speed cameras suffer from high image noise in lowlight conditions.

We counter this trade-off by incorporating multiplexing into our sampling scheme. Multiplexing enables acquiring more light per pixel. This is similar in spirit to acquiring images using multiplexed illumination for achieving higher SNR.

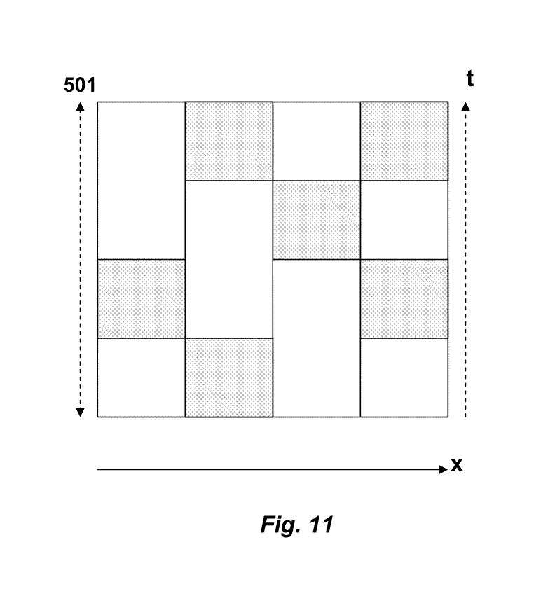

By using multiplexed pixels, as shown in FIG. 11, each pixel gathers more light resulting in a higher SNR. In one embodiment, we use Hadamard codes to multiplex.

Post-acquisition reshaping of the voxels can be achieved by de-multiplexing the codes. Each pixel is on for approximately 50% of the time. The gain is \sqrt{K/2}. The gain is K/2 for static regions of the scene because we do not require any demultiplexing.

SNR Gain with Multiplexed Sampling

For example, the scene includes a rapidly moving object and a static object. With multiplexing, each pixel gathers more light resulting in a higher SNR in the acquired images. The SNR gain for multiplexed sampling, when compared with identity sampling as in FIG. 5A, is larger for the static parts of the scene as compared to the moving regions.

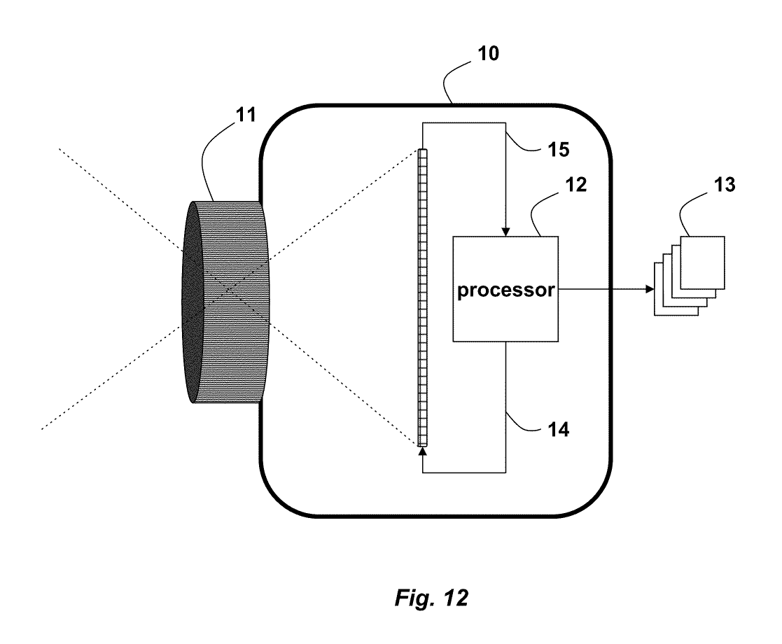

FIG. 12 shows our camera 10. The camera includes a lens 11, sensor 12 and processor. The output of the camera is a sequence of images 13.

The processor generates a signal 14 which controls an time for each pixel of the sensor, which can vary. The sensor outputs a signal 15 when a particular interval is complete, that is the image 13.

Structured Light

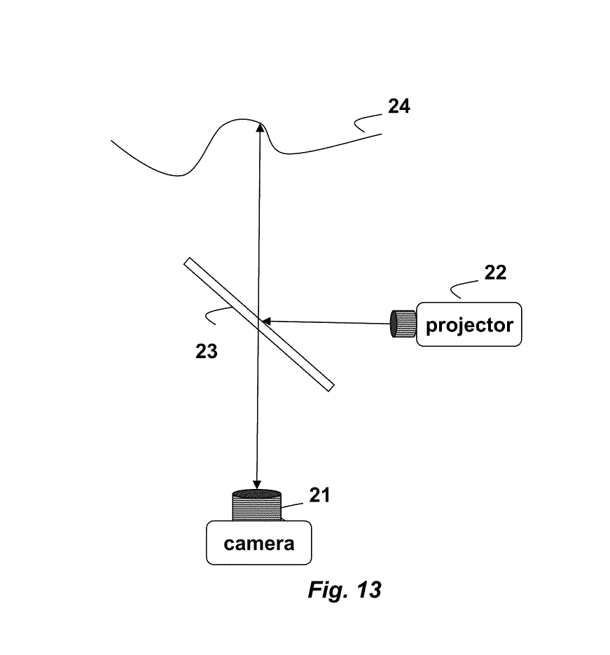

FIG. 13 shows an alternative embodiment that uses a conventional camera 21, and a conventional digital light projector (DLP) which can control the projector pixels on an individual basis at extremely rapid rates, e.g., 2 kHz.

The projector illuminates the scene via a beam splitter 23 to achieve a rapid per pixel temporal modulation during the integration time of the camera to achieve the desired spatio-temporal resolution with a maximum frame-rate of 240 Hz., even though the frame rate of the camera is only 15 Hz.

Method Steps

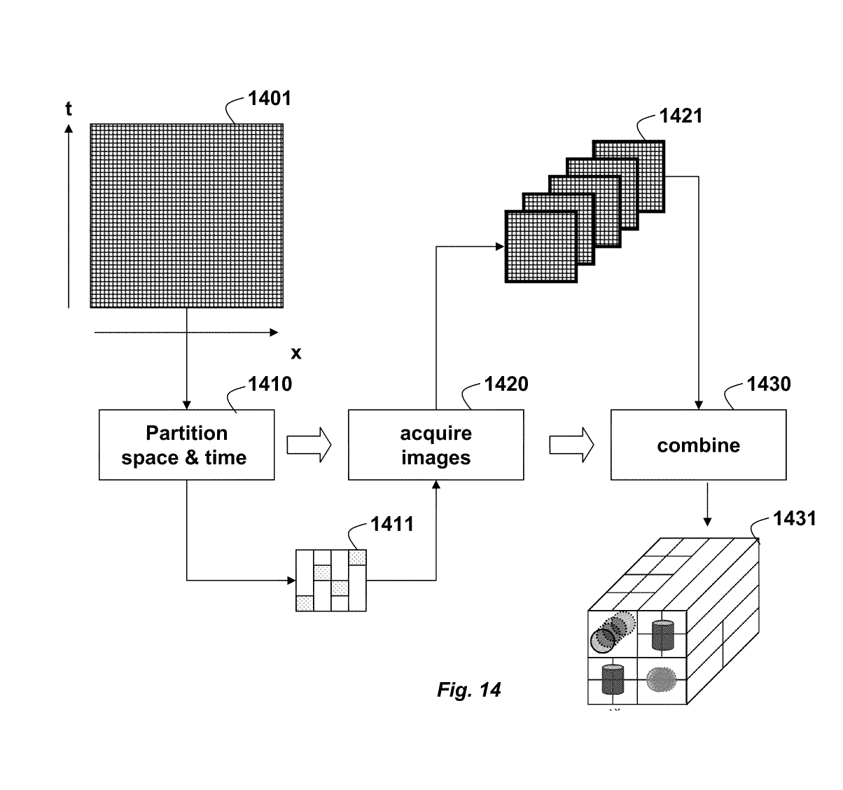

FIG. 14 show the basic steps of our method. The method can be performed by the processor 14 as the images are acquired, or any time later by a conventional processor including memory and input/output interfaces as known in the art.

The method partitions 1410 pixels of a sensor 1401 of a camera into multiple sets 1411 of the pixels, while the integration time for each image is partitioned into multiple intervals.

Each image 1421 is then acquired 1420 while some of the pixels in each set are ON for some of the intervals, while other pixels in the set are OFF for some of the intervals.

Then, the pixels of the images 1421 are combined 1430 into a space-time volume 1431 of voxels, wherein the voxels have varying spatial resolutions and varying temporal resolutions.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for acquiring a sequence of images of a scene with a single camera, wherein the sequence of images has varying spatio-temporal resolutions, comprising the step of:
partitioning spatially adjacent pixels of a sensor of a camera into a plurality of sets of the pixels;
partitioning temporally an integration time for acquiring each set of pixels into a plurality of intervals;
acquiring each image while some of the pixels in each set are ON for some of the intervals, while other pixels are OFF;
combining the pixels of the images into a space-time volume of voxels, wherein the voxels have varying spatial resolutions and varying temporal resolutions.

2. The method of claim 1, wherein the scene has static regions and moving regions, and wherein the static regions in the space-time volume have a higher resolution that the moving regions, and the moving regions have a higher temporal resolution than the static regions.

3. The method of claim 1, wherein the spatial resolution and the temporal resolution for each pixel is determined independently.

4. The method of claim 1, further comprising:
marking the regions as the static regions or the moving regions.

5. The method of claim 4, wherein the regions are marked using background subtraction.

6. The method of claim 4, wherein the regions are marked using motion segmentation.

7. The method of claim 1, wherein the pixels are ON for multiple intervals during the integration time.

8. The method of claim 1, wherein the camera is conventional, and further comprising:
illuminating the scene with a structured light pattern to turn the pixels ON and OFF.

9. The method of claim 8, wherein the structured light pattern uses Hadamard codes.
